(19) United States
(12) Patent Application Publication
(10) Pub. No.: US 2020/0002538 A1
(43) Pub. Date: Jan. 2, 2020

(54) COMPOSITION AND METHOD FOR TREATING AN ASPHALT PAVEMENT WITH A VOID-FILLING ASPHALT EMULSION

(71) Applicant: Heritage Research Group, Indianapolis, IN (US)

(72) Inventors: Herbert L. Wissel, Indianapolis, IN (US); Anthony J. Kriech, Indianapolis, IN (US); Marvin Keller Exline, Terre Haute, IN (US); Steven Michael Bakeis, West Lafayette, IN (US); Campbell Behn Higbie, Lexington, IN (US); Andrew Jacob Eicher, Carmel, IN (US)

(73) Assignee: Heritage Research Group, Indianapolis, IN (US)

(21) Appl. No.: 16/454,290

(22) Filed: Jun. 27, 2019

Related U.S. Application Data
(60) Provisional application No. 62/693,130, filed on Jul. 2, 2018.

(51) Int. Cl. C08L 95/00

(52) U.S. Cl. CPC C08L 95/005; C08L 2555/62

(57) ABSTRACT

A void filling asphalt emulsion and a method of using the void filling asphalt emulsion to fill voids below the surface of an asphalt pavement. The void filling emulsion is prepared by forming a base asphalt emulsion having about 45 to 75 wt. % of an asphalt content, and combining the base asphalt emulsion with a surface tension reducing solution to produce a void filling asphalt emulsion that has about 25 to 50 wt. % of an asphalt content. When applied to an asphalt pavement the void filling emulsion penetrates into the asphalt pavement and fills voids in the asphalt pavement. The void filling emulation further being water resistant so as not to be washed off a pavement surface by water after being applied to the pavement.

### CROSS REFERENCE TO RELATED APPLICATIONS

This application claims the benefit of U.S. Provisional Application No. 62/693,130 filed Jul. 2, 2018, which is hereby incorporated by reference in its entirety.

### FIELD

The present disclosure relates generally to surface treatment compositions that are used to maintain asphalt pavements. More particularly, the present disclosure is directed to a void filling asphalt emulsion composition that penetrates asphalt pavements and fills voids in the pavements that are below the surface then cures quickly within the pavement pore structure.

### BACKGROUND

Surface treatments used for maintenance of asphalt pavements generally include coatings, penetrating or rejuvenating sealants, and aggregate-based seals.

Surface treatment coating compositions only provide a moisture and UV light barrier on the top surface of asphalt pavements. Penetrating or rejuvenating sealants are asphalt-based compositions that are blended with water or cutbacks that allow them to soften the surface of the pavement to penetrate the surface layer only slightly, which increases the pavement's flexibility to mitigate the impact of environmental aging.

None of the pavement maintenance products available to date address or correct structural features of the original pavement that were created at the time the pavement was constructed; nor do they address structural features below the surface of the pavement when the pavement maintenance products are applied and used. The preferred time of application to receive maximum benefit from the reduced air voids is shortly after construction. This allows for less oxidation of the asphalt to occur and reduced deterioration from water, resulting in a greater life of the pavement. Accordingly, there remains a need to develop asphalt-based compositions for the treatment and maintenance of asphalt pavement.

### BRIEF SUMMARY

According to various features, characteristics and embodiments which will become apparent as the description thereof proceeds, the present disclosure provides a void filling asphalt emulsion comprising about 25 to about 50 wt. % of an asphalt content. In certain embodiments, the method comprises: forming a base asphalt emulsion having about 45 to 74 wt. % of an asphalt, and combining the base asphalt emulsion with a wetting agent to produce a void filling asphalt emulsion comprising about 25 to about 50 wt. % of the asphalt.

The present disclosure further provides a method for filling voids in an asphalt pavement. In certain embodiments the method comprises:

providing a void filling asphalt emulsion that has about 25 to 50 wt. % of an asphalt; and

applying the void filling emulsion onto an asphalt pavement.

In certain embodiments, the method of filling voids in a pavement comprises:

selecting a void filling asphalt emulsion comprising about 25 to about 50 wt. % of an asphalt;

identifying an asphalt pavement, said pavement comprising a surface and voids below the surface;

applying the void filling emulsion onto the surface of the pavement; and

allowing at least a portion of the void filling emulsion to penetrate into the voids of the pavement.

The present disclosure also provides an asphalt pavement that has been treated with the void filling asphalt emulsion.

### BRIEF DESCRIPTION OF THE DRAWINGS

FIG. 1 is graph showing the percentage of mass passing through the filter (“% Mass passing Filter”) obtained from tests of three proprietary aqueous void reducing emulsions containing different emulsifiers.

FIG. 2 is a graph showing the water resistance, measured as percentage of mass retained (“% Mass Retained”) obtained from tests of three proprietary aqueous void reducing emulsions containing different emulsifiers.

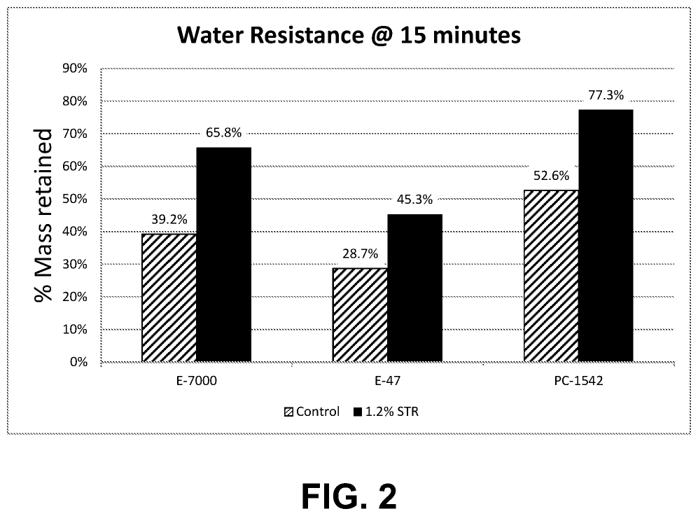

### DETAILED DESCRIPTION

The useful life of an asphalt pavement can be highly dependent upon its ability to be uniformly compacted at the time of construction of the pavement so as to create a dense matrix of asphalt coated aggregate having limited interconnected void volumes that resists the infiltration of water into the pavement structure. During the construction process, handling of the asphalt mixture can cause segregation, which can cause a non-uniform blend of the pavement aggregates, which can lead to coarse areas in the finished pavement with higher interconnected air voids. These coarse areas can comprise a high concentration of interconnected void structures that detrimentally allow water and air to permeate the asphalt pavement. The effect of such water and air intrusion can lead to more rapid oxidation of the asphalt binder and/or removal of the asphalt coating on the aggregate caused by water trapped in the pavement. Poor or inadequate compaction can also cause high air voids with high permeability to air and water. Paving in cool or cold weather can also lead to higher air void mixtures. Areas with more hand work around utilities or structures also lead to higher permeable pavements.

Construction of longitudinal and transverse joints also can produce higher air void pavements in the area around the joint. Higher air and water permeable pavements can lead to the action of water damaging the asphalt aggregate film which can lead to stripping of the asphalt film on aggregate leading to early pavement failure. Traffic loads cause mechanical action which, in addition to the higher temperatures and water vapor, are responsible for stripping of the binder from the aggregate.

Pavements in North America typically are designed for an optimum air void content of 4% in the laboratory. Most state DOT's only advise 6-7% air void in practice on roads. The result is that the road has more air and water permeability and age more quickly than designed. Once an asphalt pavement is in place, compacted and allowed to cool, the void structure is set and little post compaction occurs outside the wheel path. Agencies have required density specifications that must be met; and if the pavement is below the minimum requirements set by the Agency, pay adjustments will be made to account for loss of pavement life or, in the worst cases, the pavement may be milled and removed and a new mixture put in its place.

Traditional asphalt emulsions that are capable of being diluted with water have been used as surface treatment compositions in an effort to reduce the intrusion of air and water into asphalt pavements. These emulsions, even when diluted to the point of reducing them to have a low asphalt content, typically have minimal penetration into the voids of a pavement. Accordingly, at best they only result in temporarily sealing the surface of a pavement. Application rates of greater than 0.1 gal/yd² are avoided, because they may leave too much asphalt on the surface, thus resulting in loss of surface texture and reduced pavement friction and its associated safety issues. Higher concentrations of surfactant in the emulsions have been tried in an effort to increase their ability to penetrate into the voids in pavements. Increasing the amount of surfactant usually results in increasing the emulsion stability while greatly slowing the emulsion's ability to set or cure, thus making it very susceptible to leaching from uncured asphalt emulsion from the pavement in the case of a rain event. This lack of water resistivity is an environmental concern releasing unbroken asphalt emulsion into ditches and streams.

Traditional asphalt emulsions are typically made using a colloid mill. The asphalt content of such emulsions must be high enough for the shearing action of the colloid mill to create small, uniform droplets of asphalt suspended in a water/soap solution. Typically, the asphalt content would be between 45 wt. % and 74 wt. %. For such traditional formulations, using an asphalt content below 45 wt. % at the time of shearing can create inconsistent particle size. Using an asphalt content higher than 74 wt. % creates a risk of inverting the emulsion from an oil in water to a water in oil emulsion. This results in the water/soap phase being suspended in a continuous phase of asphalt.

The present disclosure provides an asphalt emulsion surface treatment composition that penetrates asphalt pavements and fills interconnected air voids beneath the surface of asphalt pavements then cures quickly providing improved resistance to water. Because the penetrating capability and water resistivity do not typically coexist in an asphalt emulsion at the same time with standard asphalt emulsions, the void-filling capabilities of the asphalt emulsions provided herein having about 25 to about 50 wt. % of an asphalt content are altogether surprising and unexpected.

The present disclosure provides an asphalt emulsion composition referred to as a “rapid penetrating emulsion” or “void filling emulsion” or “reduced permeability emulsion” that has been developed to penetrate into asphalt pavements and fill voids below the surface of such pavements. In certain embodiments, the asphalt emulsion composition of the present disclosure comprises an asphalt emulsion that is made by the combined use a primary emulsifier and a surface tension reducing surfactant. In certain embodiments, the primary emulsifier is used to produce a base asphalt emulsion, and the surface tension reducing surfactant is added to effect penetration into an asphalt pavement. However when combined together these materials cure quickly producing a pavement that is resistant to water and reduced permeability.

In certain embodiments, the base asphalt emulsion is made by combining a water and an asphalt phase to create a homogenous solution. In certain embodiments, this is done by shearing asphalt with a soap solution of water and the primary emulsifier, as well as any additional additives needed before emulsification (depending on desired application and physical characteristics). The shearing may be conducted, for example, in a colloidal mill where the components are combined at predetermined ratios to get the final desired composition of the base emulsion.

In certain embodiments, the void reducing emulsion of the can be created using the post-addition of a surface tension reducing solution that includes a wetting agent (i.e., surface tension reducing solution (water and surfactant)) to the base asphalt emulsion. The final desired asphalt content of the void filling emulsion can be calculated to determine how much of the surface tension reducing solution needs to be added to the base asphalt emulsion to form the final product. In certain embodiments, this pre-calculated volume of solution and emulsion is mixed and can be pumped into an empty mixing tank, tanker truck, or emulsion distributor. In certain embodiments, the mixture is then agitated into a homogenous solution before being applied onto a desired application area.

In certain embodiments, the primary emulsifier may be selected from emulsifiers that are commonly used to form asphalt emulsions. In certain embodiments, the emulsion compositions of the present disclosure are diluted with water only; however, in alternative embodiments the emulsions can be diluted with a weak soap solution made using the same emulsifier/surfactant as used for the primary emulsifier to provide better emulsion stability. In certain embodiments, when diluting with the wetting solution (additional surfactant and water), care should to be taken to avoid over stabilization of the emulsion which can result in the emulsion not wanting to revert to the cured asphalt state in a timely fashion. Such over-stabilization could create a situation where the application of the diluted emulsion may be susceptible to leaching (poor water resistivity) for an extended period of time from, for example, further dilution by a rain event.

Primary emulsifiers will be readily appreciated by those of skill in the art. Exemplary primary emulsifiers tested in accordance with the present disclosure included tall oil-based carboxylates and alkyl amines. Non-limiting examples of tall oil-based carboxylates include PC-1542 (available from Ingevity Corporation), crude tall oil (available from Champion Paper Company) and Indulin® SA-L (available from Ingevity Corporation). Non-limiting examples of alkyl amines include, Indulin® SBT-50 (available from Ingevity Corporation), Redicote® E-7000 (available from AkzoNobel), and Redicote® E-47NPF (available from AkzoNobel).

Suitable surfactants will be readily appreciated by those of skill in the art. Exemplary surface tension reducing surfactants tested in accordance with the present disclosure include polymeric surfactants (ethoxylates) and mixed stream surfactants (ethoxysulfates, sulfates, sulfonates and carboxylates). Non-limiting examples of polymeric surfactants include Redicote® E-95 (available from AkzoNobel), TRITON™ X-100, TERGITOL™, TRITON™ RW-50 and ECOSURT™ EH-9 (all available from Dow Chemical), and LUTENSOL® XL 80, LUTENSOL® XP 80, and LUTENSOL® XP 90 (available from BASF). Non-limiting examples of mixed stream surfactants include BIO SOFT® LD-95 (available from Stepan Company), Dawn 2× (available from Proctor & Gamble), Redicote® E-47 NPF (available from AkzoNobel), Palmolive 11119 and Palmolive 11118 (available from Colgate-Palmolive Company).

In certain embodiments, the void filling emulsion can be made in a 2-step process that includes a primary emulsion. In certain embodiments, the primary emulsion comprises an aqueous solution containing an emulsifier and about 45 wt. % to about 75 wt. % of an asphalt (i.e., a bituminous compound). Subsequently, the primary emulsion may be diluted to any asphalt content using the surface tension reducing surfactant diluted in water to provide the final void filling emulsion.

Surprisingly—and without being bound to any particular scientific theory—in certain embodiments it was discovered that the primary emulsifier functions to stabilize the asphalt droplets during initial shearing to create an emulsion. Subsequent addition of the surface tension reducing surfactant creates an enhanced ability for the void filling emulsion to penetrate asphalt pavements. With regard to such embodiments, it was further discovered that the surface tension reduction not only aids the penetrating capacity, but also enhances the early water resistance of the emulsion.

Thus, in certain embodiments, Applicant has surprisingly and unexpectedly discovered that addition of the surface tension reducing surfactant into the primary emulsifier soap at the time of initial emulsification using e.g. a colloid mill does not create the same properties as a process that first creates an emulsion with primary emulsifier with subsequent dilution using the surface tension reducing surfactant. Reduction of surface tension caused by adding the wetting agent at the time of emulsification was found to create emulsion instability and, in some cases, to the point an emulsion could not be formed. In addition, direct addition of undiluted surface tension reducing surfactant to an emulsion was also found to be detrimental to the stability of the emulsion. In certain embodiments, to achieve the desired results, it was discovered that the surface tension reducing surfactant needs to be added to the dilution water that is used to dilute the emulsion to its final asphalt content.

Suitable procedures for producing void-filling emulsions described herein may include the following exemplary processes. First, create the base (primary) asphalt emulsion using a primary emulsifier. The starting or base emulsion will have an asphalt content of from about 45 wt. % to about 75 wt. % and a typical asphalt emulsion particle sized sheared by means of a colloid mill. After formation the resulting primary emulsion should be allowed to cool and stabilize. Next, water with a surface tension reducing surfactant (the wetting agent solution) according to the present disclosure is added to the primary emulsion at a temperature near the emulsion temperature to dilute the emulsion, reduce the asphalt content, and form the void filling emulsion of the present disclosure. The final asphalt content of the void filling emulsion may range from about 30 wt. % to about 50 wt. % depending upon the pavement to be treated and the desired penetrating depth. The amount of surface tension reducing surfactant is generally in the range of about 0.1 to 3 wt. % based on the mass of the total diluted emulsion system. In certain embodiments, other emulsion additives that can be added, but may not essential to the void filling properties of the present disclosure include rejuvenators, oil type emulsions, and others that do not adversely affect the present disclosure.

The void filling emulsion of the present disclosure may be applied to an asphalt pavement in a single pass at a heavier application rate if deeper penetration is desired. Alternatively, the void filling emulsion can be applied in multiple, lower rate applications to limit the depth of penetration and fill more voids in the upper pavement layer. The void filling emulsion can be applied to the surface using any suitable method known to those of skill in the art, including by hand or using a mechanical apparatus, such as a vehicle having spray bar applicators (e.g., transverse bars, longitudinal bars, or combinations thereof). In certain embodiments, the emulsion may be “brushed” along the surface to help ensure a uniform application across the surface, as well aid in penetration. In certain embodiments, the brushing may occur through the use of a broom or broom-like device. For example, in certain embodiments a spray applicator vehicle may drag an industrial-type broom behind a transverse spray bar applicator, ensuring an even distribution of material. In other embodiments, the spray bar device may be modified to include a broom-like structure, such that brushing of the material occurs contemporaneously with the ejection of the emulsion from the spray nozzles.

The depth at which voids in an asphalt pavement can be filled may be altered by adjusting the asphalt content of the diluted starting emulsion and the amount of surface tension reducing surfactant in the finished emulsion. In certain embodiments, a higher asphalt content together with a lower amount of surface tension reducing surfactant will produce an emulsion with a reduced ability to migrate into deeper voids in an asphalt pavement. For some applications, this will be a desirable property. Examples include pavements in which the voids are in excess of 10% of the pavement's volume, such as cold-in-place recycled asphalt pavements. In such cases, the recycled pavement may be in excess of three inches thick. In such embodiments, the amount of void filling emulsion required to fill the voids in such pavement structures would be very high—on the order of approximately 1.7 gal/yd².

By controlling the asphalt content of the diluted starting asphalt emulsion and the amount of surface tension reducing surfactant in the finished asphalt, it is possible in certain embodiments to limit the penetration of the void filling emulsion to no more than the top inch of pavement, which would only require an application of 0.6 gal/y².

For purposes of the present disclosure, the void filling capability can be judged by a combination of two testing protocol: surface texture as measured by the sand patch test ASTM E965; and the National Center for Asphalt Technology (NCAT) falling head field permeability test. The desired result is to create a significantly reduced falling head field permeability test result while at the same time create minimal effects on the surface texture. This combination is an indication that the void filling emulsion has penetrated the asphalt pavement and not just remained at the surface of the pavement.

### EXAMPLES

The following non-limiting examples are provided to demonstrate features and characteristics of the present disclosure. In the Examples and throughout, percentages are given as weight percentages unless otherwise indicated or determined from context.

### Example 1

In this Example, test sections were placed on two test road asphalt pavement surfaces. Both roads were paved the year the test sections were placed, and the hot mix asphalt for each was produced from the same hot mix plant from the same mix design. The pavements were both treated with void filling emulsion at the centerline longitudinal construction joint. The pavements were tested for texture and permeability prior to the treatment with void filling emulsion according to the present disclosure. The locations for the initial tests were marked and after the void filling emulsion treatment, the same locations were retested for surface texture and permeability. The variables of the tests included the asphalt content of the void filling emulsion and application rate.

The void filling asphalt emulsion compositions tested in this Example were made by combining the same base asphalt emulsion with a surface tension reducing surfactant (STR) as shown below in Table 1. The base asphalt emulsion consisted of 59 wt. % asphalt, and a non-ionic emulsifier (Redicote® E-7000, 1.8 wt. % based on total weight of void filling emulsion). An alcohol ethoxylate wetting agent solution (Redicote® E-95) was used as the STR surfactant. “Final Amounts” are based on total weight of final void filling asphalt emulsion.

TABLE 1

| | Final Amount of | Final amount of | |
|---|---|---|---|
| | STR | Asphalt | Application Rate |
| Road 1 | 0.8 wt. % | 44 wt. % | 0.22 gal/yd² |
| Road 2 | 0.4 wt. % | 47 wt. % | 0.14 gal/yd² |

The data from the test sections are shown in Table 2 below.

TABLE 2

| | Asphalt Content (%), | Texture | | NCAT | Δ Permeability |
|---|---|---|---|---|---|
| | Application Rate | Depth | ΔTexture (mm), | Permeability | (×10^{e-5} cm/sec), |
| Road | (gal/yd²), WA(%) | (mm) | % Change | (×10^{e-5} cm/sec) | % Change |
| 1 pre-treat | | 0.439 | | 1056 | |
| 1 post-treat | 44, 0.22, 0.8 | 0.422 | 0.017, 3.9 | 53 | 1003, 95 |
| 2 pre-treat | | 0.439 | | 874 | |
| 2 post-treat | 47, 0.14, 0.4 | 0.386 | 0.053, 12.1 | 127 | 747, 85 |

The results from the test section date in Table 2 demonstrate that when the void filling emulsion has a higher asphalt content the penetration into a pavement is not as deep as when the void filling emulsion has a lower asphalt content. More importantly, as the surface tension reducing surfactant is increased a higher application of void filling emulsion could be applied while affecting very little change in the surface texture. This is an indication that the void filling emulsion penetrated the surface and reduced voids in the pavement structure, and not just on the surface of the pavement as in the case of other typical emulsions.

The void filling emulsions tested in Example 1 penetrated the centerline area of the pavements in 30 minutes or less. Based on calculations, Road 2 had 93% of the emulsion that was applied penetrate into the compacted asphalt mix. By comparison, Road 1 that had a higher asphalt content and lower amount of surface tension reducing surfactant had 86% of the void filling emulsion penetrate the compacted asphalt mix.

### Example 2

In this Example the texture depths from the road sections of Example 1 were measured before and after application. The measurements were made after the water had left the emulsion, thus measuring the emulsion residue thickness remaining on the pavement surface. Knowing the application rate and residue content, the actual percent of emulsion applied that penetrated the asphalt mixture was calculated and is provided in Table 3 below.

TABLE 3

| | | | | Emulsion | | |
|---|---|---|---|---|---|---|
| | Pre-, Post- | Residue | Emulsion | Asphalt | | Emul. in |
| | Treatment | Thickness | Rate | Content | Surface Emul. | pavement |
| Road | (mm) | (mm) | (gal/yd²) | (%) | (gal/yd²) | (gal/yd²), (%) |
| 1 | 0.439, 0.401 | 0.0038 | 0.22 | 44 | 0.015 | 0.205, 93.2 |
| 2 | 0.439, 0.386 | 0.053 | 0.14 | 47 | 0.020 | 0.120, 86.0 |

As seen from the data in Table 3 a high percentage of the void filling asphalt emulsion penetrated into the asphalt roads.

### Laboratory Test to Classify an Emulsion's Penetrating Capability

Compacted asphalt mixtures pavements have a void structure that is determined by a non-all-inclusive list that includes the type and size of aggregates, the design gradation, asphalt content, mix temperatures, compaction, etc. Typical asphalt emulsions placed on the surface of compacted asphalt pavements tend to remain on the surface of the pavements rather than penetrate below the pavement surface. Diluting an emulsion with water to reduce the asphalt content and emulsion viscosity may allow for minor penetration into an asphalt pavement. Placing a diluted asphalt emulsion on the surface of an asphalt pavement can be comparable to placing the emulsion on a filter. The smaller openings in a filter (comparable to the voids in a pavement), the more difficult it will be for an asphalt emulsion to pass through the filter (pavement. Applicant determined that a wire/mesh sieve could be used as a filter to represent and determine and ability of an emulsion to penetrate an asphalt pavement. Emulsions that performed well in the field and others that did not perform well at penetrating asphalt pavements were evaluated during the course of the present disclosure using a laboratory wire/mesh sieve evaluation test. Based upon testing results it was determined that a #500 mesh (30 micron) sieve was useful to differentiate good from poor penetrating emulsions.

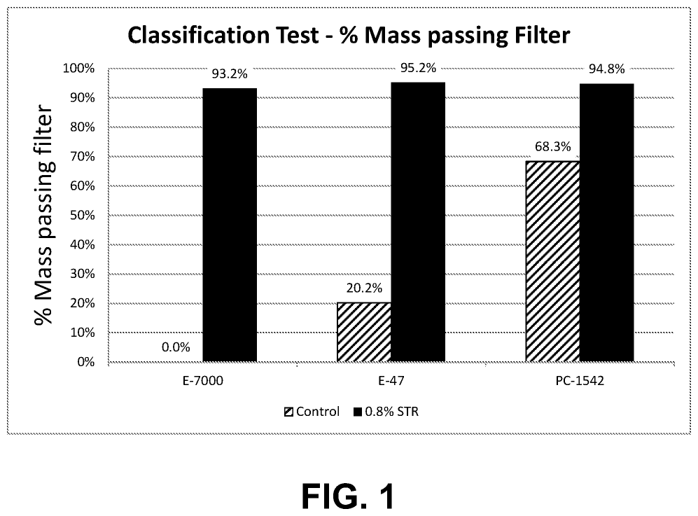

Applicant tested three proprietary aqueous void reducing emulsions containing different emulsifiers (Redicote® E-7000, Redicote® E-47NPF, and PC-1542 (Ingevity)) and containing 0.8 wt. % surfactant (Redicote® E-95) to classify the penetrating capacity of the void filling emulsions. The control samples contained the emulsifiers, but excluded the STR surfactant. The results of these tests are shown in FIG. 1.

The test to classify the penetrating capacity of the void filling emulsions of the present disclosure involves diluting the emulsions to a test standard solids content of 38 wt. % and then conditioning the emulsions to a temperature of 50° C. Next a #500 sieve is placed on a tared receiver pan and 20 grams of emulsion is poured onto the sieve. After 5 minutes, the mass of emulsion that has passed through the sieve and into the receiver pan is determined. The percent of the emulsion that passes through the #500 sieve is calculated and used to classify the penetrating capacity of the emulsion.

Results from field experimentation with diluted emulsions were used to determine a value for good penetration into a pavement surface.

Laboratory Test to Determine an Emulsions Resistance to Water while Curing

Some emulsions when applied to an asphalt pavement for the purpose of filling voids in the pavement are very stable and remain as an emulsion over an extended period of time due to very slow release of the water phase of the emulsion. During the time the emulsion is releasing the water, it is susceptible to rain events where the emulsion can be flushed out of voids in a pavement and leach to the side of the pavement. During the course of the present disclosure the inventors developed a laboratory test method to measure an emulsion's resistance to water over time.

The test method developed by the present inventors quantifies emulsion runoff using a water effect at different time intervals. The method allows differences in water resistance between different emulsion formulations to be measured and compared. Materials used for the test include pre-cut 80 grit sandpaper strips that provide a textured surface test surface, 100 mL plastic sample containers to catch liquid runoff, a titration burette filled with deionized water to simulate a water stream, a 50° C. oven for emulsion conditioning, and samples of the emulsions that are to be tested. The test procedure involves simultaneously pouring an emulsion to be tested on several sandpaper strips (Time=0 minutes) and the added mass is measured. The theoretical value of asphalt residue is then calculated based on the measured asphalt content of the sample. The coated sandpaper strips are positioned at a 45 angle and each is exposed to 10 ml of water from the burette at full opening after their individual specific time intervals (15, 20, 30, and 45 minutes). After the water exposure the strips are placed into an oven to cure to constant mass at 50° C. The strips are then weighed again, and the residue retained after water exposure is calculated to give a quantitative measurement of resistance to being carried off by water at different time periods, which is referred herein as the water resistance of the emulsion.

Applicant tested three proprietary aqueous void reducing emulsions containing different emulsifiers (Redicote® E-7000, Redicote® E-47NPF, and PC-1542 (Ingevity)) and containing 1.2 wt. % surfactant (Redicote® E-95) for resistance to water. The control samples contained the emulsifiers, but excluded the STR surfactant.

The void filling emulsion of the present disclosure was found to be capable of penetrating and filling voids in asphalt pavement and be resistant to water in less than an hour (>60% residue is retained).

The void filling emulsion of the present disclosure can be used in conjunction with all types of asphalt pavements, including, but not limited to, new hot mix asphalt pavements, longitudinal joints, aged hot mix asphalt pavements, cold in place recycled pavements, cold central plant pavements, cold mix asphalt pavements, etc.

Although the present disclosure has been described with reference to particular means, materials and embodiments, from the foregoing description, one skilled in the art can easily ascertain the essential characteristics of the present disclosure and various changes and modifications can be made to adapt the various uses and characteristics without departing from the spirit and scope of the present disclosure as described above and set forth in the attached claims.

1. A method of preparing a void filling asphalt emulsion, comprising:
providing a base asphalt emulsion having about 45 to about 75 wt. % of an asphalt; and
combining the base asphalt emulsion with a wetting agent solution to produce a void filling asphalt emulsion, wherein the asphalt comprises about 25 to about 50 wt. % of the void filling asphalt emulsion.

2. The method of claim 1, wherein the asphalt comprises about 30 to about 45 wt. % of the void filling asphalt emulsion.

3. The method of claim 1, wherein the asphalt comprises about 38 to about 44 wt. % of the void filling asphalt emulsion.

4. The method according to claim 1, wherein the base asphalt emulsion comprises water and at least one primary emulsifier.

5. The method of claim 4, wherein the primary emulsifier comprises at least one of a tall oil based carboxylate or an alkyl amine.

6. The method according to claim 1, wherein the wetting agent solution comprises water and at least one surfactant.

7. The method according to claim 1, wherein the wetting agent solution comprises at least one of a polymeric surfactant or a mixed stream surfactant.

8. The method according to claim 1, wherein the wetting agent solution comprises at least one of an alcohol ethoxylate, an amine ethoxylate, an acetylenic diol ethoxylate, or a propoxylate.

9. The method according to claim 1, wherein wetting agent solution comprises at least one of an ethoxysulfate, a sulfate, a sulfonate, a diamine, a fatty acid, an ether, a hydroxythioether, a siloxane, a fluorosurfactant, a quaternary salt, a betains, or a carboxylate.

10. The method according to claim 1, wherein the void filling asphalt emulsion comprises about 0.1 to about 3 wt. % of a surfactant based on the total weight of the void filling asphalt emulsion.

11-60. (canceled)

61. An emulsion comprising:
water;
about 25 to about 50 wt. % of an asphalt; and
at least one emulsifier.

62. The emulsion of claim 61, wherein the asphalt comprises about 30 to about 45 wt. % of the emulsion.

63. The emulsion of claim 61, wherein the asphalt comprises about 38 to about 44 wt. % of the emulsion.

64. The emulsion of claim 61, further comprising at least one surfactant.

65. The emulsion of claim 61, wherein the emulsion exhibits a penetration value of at least 80 wt. % within 5 minutes when passing the emulsion through a #500 mesh sieve at 50° C.

66. The emulsion of claim 65, wherein the emulsion exhibits a penetration value of at least 85 wt. %.

67. The emulsion of claim 65, wherein the emulsion exhibits a penetration value of at least 90 wt. %.

68. The emulsion of claim 65, wherein the emulsion exhibits a penetration value of at least 95 wt. %.

69. The emulsion of claim 65, wherein the emulsion exhibits a penetration value of about 90 to about 99.9 wt. %.

70. The emulsion of claim 61, characterized in that at least a portion of the emulsion is capable of penetrating into below-surface voids of an asphalt after application to the asphalt's surface.

71-98. (canceled)
